(19) United States
(12) Patent Application Publication
(10) Pub. No.: US 2024/0262016 A1
(43) Pub. Date: Aug. 8, 2024

(54) Tool insert for the production of an object, production method and object

(71) Applicant: Hilti Aktiengesellschaft, Schaan (LI)

(72) Inventors: Johannes Alfred MARDER, Feldkirch (AT); Ward BARTHOLOMEE, Aachen (DE)

(21) Appl. No.: 18/565,449

(22) PCT Filed: May 18, 2022
(86) PCT No.: PCT/EP2022/063402

§ 371 Date: Nov. 29, 2023

(30) Foreign Application Priority Data
Jun. 1, 2021 (EP) 21177170.4

(51) Int. Cl. B29C 33/30; B29C 45/00; B29C 45/16; B29C 45/26; B29C 45/37; B29K 77/00; B29L 31/00

(52) U.S. Cl. CPC B29C 33/302; B29C 45/16; B29C 45/263; B29C 45/2675; B29C 45/372; B29C 45/376; B29C 2045/0093; B29C 2045/1692; B29C 2045/2677; B29C 2045/2697; B29C 2045/378; B29K 2077/00; B29L 2031/729

(57) ABSTRACT

A tool insert for the production of an object by an injection molding method, wherein the injection molding tool includes an insert frame and at least one lamination assembly having a plurality of individual laminations, wherein the at least one lamination assembly is inserted in the insert frame. In further aspects, the invention relates to a method and a system for producing an object having curved surfaces using the tool insert, and to an object which can be produced with the method. The system for producing an object comprises a tool insert and a sliding element. A basic idea of the invention is that curved surfaces can be introduced into the object in that the insert frame has curved surfaces and/or at least one distortion cushion is arranged between the insert frame and the at least one lamination assembly.

The present invention relates to a tool insert for the production of an object by an injection molding method.

### BACKGROUND OF THE INVENTION

It is known in the prior art to use tool inserts for use as a mold in injection molding methods, wherein the tool inserts can comprise lamination assemblies consisting of a plurality of individual assemblies. Such tool inserts can also be referred to as injection molding tools. Such injection molding tools can be used in particular for producing complexly shaped objects, such as, for example, grinding plates for grinding disks for use in a grinding machine. The lamination assemblies can be arranged in an insert frame and the individual laminations of the lamination assemblies can have depressed microstructures which allow microstructuring of the surface of the object to be produced.

### SUMMARY OF THE INVENTION

For example, it would be desirable if such tool inserts could be used to mold Velcro hooks on a surface of the grinding plate. The Velcro hooks can then interact with a Velcro fleece on an underside of a grinding attachment and form a Velcro (fastener) connection with which the grinding attachment can be fastened to the grinding plate.

Grinding machines for machining substrates are known in the prior art. Such grinding machines have a motor with which a grinding disk can be driven. The grinding disk comprises a grinding plate and a grinding attachment. The grinding attachment comprises an abrasive which is brought into contact with the substrate and machines the substrate by a rotational movement of the grinding disk. It is known that the grinding attachment or the abrasive can wear, and therefore the attachment has to be regularly exchanged. To allow such an exchange, various connection methods between the grinding plate and the grinding attachment are known in the prior art. In particular, the grinding plate and the grinding attachment can be connected to one another by a Velcro fastener connection. Here, the Velcro hooks are usually mounted on the grinding plate, and the Velcro fleece is mounted on the grinding attachment. The Velcro hooks usually form a Velcro hook fabric which is adhesively bonded to the grinding plate, with this adhesive connection having proven to be technically challenging in the past. In particular, the adhesive connection is associated with disadvantages, such as a complicated pretreatment of the components involved by mechanical reworking, degreasing, application of a primer, a low process reliability, the requirement of manual work steps, and a multipart process chain with injection molding of the basic body of the grinding plate, finishing of the components and application of the Velcro tape. Consequently, the production process for grinding disks in which a Velcro hook fabric is fastened to the grinding plate with an adhesive connection is cost-intensive, complex and labor-intensive.

To overcome the disadvantages of an adhesive connection, it has been proposed in the prior art to produce the Velcro hooks by an injection molding method and to “mold” them onto the grinding plate. For example, it is proposed in U.S. Pat. No. 5,656,226 A to use layered tool inserts to apply the Velcro hooks to a surface of the grinding plate. Here, the geometry of the Velcro hooks is repeatedly cut into thin laminations, with these laminations being joined together to form a lamination stack, as a result of which the layered tool insert is obtained. In particular, undercut microstructures can be realized in this way.

The introduction of the geometry of the Velcro hooks into the individual laminations can be achieved, for example, by a spark erosion method, which is referred to as microstructuring in the context of the present invention. The Velcro hooks are referred to as substructures in a generalizing manner in the context of the present invention. They preferably form a microstructure on the surface of the object, with this referring in an exemplary embodiment of the invention to the Velcro hook layer which can be mounted or molded on the surface of the grinding plate.

However, the methods known from the prior art, as are described, for example, in U.S. Pat. No. 5,656,226 A, have various disadvantages. First of all, frequently only part of the total surface for mounting the microstructure is available in the conventional injection molding methods. This means that only part of the available surface of the object which is to be produced can be provided with the microstructure and its substructures. In the specific exemplary embodiment of the invention, this can have a disadvantageous effect on the adhesive action between the grinding plate and the grinding attachment if the whole surface of the grinding plate is not provided with the Velcro hook layer in order to form the Velcro connection with the Velcro fleece of the grinding attachment.

Moreover, the substructures which are produced with conventional tool inserts, as are known from the prior art, are usually arranged along a straight line and parallel to one another. However, such an arrangement can lead to a nonoptimal force transmission if the substructures are used, for example, as Velcro hooks for a grinding plate of a grinding disk. The grinding plate usually has a substantially circular basic shape, whereas its surface, which is to be connected to the grinding attachment, is substantially annular in form. For these round or annular objects, the use of lamination assemblies, which usually have an angular basic shape and in which the substructures are present along a straight line and parallel to one another, can lead to an unfavorable arrangement of the microstructuring.

Consequently, in particular the following disadvantages are shown in the conventional injection molding methods, as are known from the prior art.
1. The substructures usually have a single, straight orientation. If the substructures are intended to be oriented along the load direction of a nonrectilinearly acting shear stress, a division into straight segments is required.
2. If complex components consisting of plastics are produced in multicomponent injection molding methods, a three-dimensional “distortion” can result. The term “distortion” is to be understood in the context of the invention as meaning a deviation from a geometry of the tool cavity as a result of process-induced stresses. Usually, such unwanted deformation has to be “countered” in an iterative process, that is to say that the deformation of the component is introduced into the tool in an inverted manner. For this purpose, the surface of the injection molding tool has to be machined. Surfaces which are functionalized with Velcro hooks or other substructures thus lose their desired functionality-supporting microstructuring. Tests have shown that the three-dimensional distortion occurs in radially symmetrical form in the case of substantially radially symmetrical molds.

An object of the present invention is to address the above-described deficiencies and disadvantages of the prior art and specifying a tool insert and a method for producing an object by an injection molding method with which a load path-appropriate orientation of the substructures of the microstructure is made possible. Moreover, the countering of distortions is to be made possible in order to avoid a production-related functionality loss of the surfaces of the objects. Those skilled in the art would also appreciate it if the substructures could be oriented in a circumferential direction of the complexly shaped object and an improved microstructuring of such objects which have a round or annular basic shape could be made possible by means of the invention. A further concern underlying the invention is that a connection between the object and another object to be connected thereto should be as robust and strong as possible. For example, in the context of the present invention, there should be provided a difficult-to-release connection between a grinding plate and a grinding attachment that is as durable as possible. In addition to the tool insert and the production method, it is moreover intended for an object to be provided that can be produced using the tool insert and with the production method.

The present invention provides a tool insert for the production of an object by an injection molding method, wherein the tool insert comprises an insert frame and at least one lamination assembly having a plurality of individual laminations, wherein the at least one lamination assembly is inserted in the insert frame. The tool insert is characterized in that at least one curved surface can be introduced into the object in that the insert frame has curved surfaces and/or at least one distortion cushion is arranged between the insert frame and the at least one lamination assembly. The term “tool” is preferably understood within the meaning of the invention as a “casting mold”, wherein such a casting mold can be used to produce objects or articles. The object is preferably a complexly shaped object, wherein the preferably complexly shaped object can in particular be a grinding plate for a grinding disk of a grinding device.

The invention relates in particular to a tool insert which, owing to the lamination assembly which it comprises, can preferably be referred to as a “laminar tool insert”. It is preferred within the meaning of the invention that the microstructure to be molded with its substructures is contained as negative in the tool insert. This negative counterpart structure which is contained in the tool insert or in the individual laminations of the lamination assemblies is referred to within the meaning of the invention as a “depressed microstructure” or as a “negative microstructure”. It is preferred within the meaning of the invention that the object represents the structure of the tool insert during the production of the object in the injection molding method by replicating this structure of the tool insert. As a result, the object advantageously has a three-dimensional mirror-image counterpart structure of the structure of the tool insert.

A concern of the invention is that curved surfaces can be introduced into the object to be produced. For this purpose, the invention proposes that the insert frame of the injection molding tool has at least one curved surface. Alternatively or additionally, a distortion cushion can be arranged between the insert frame and the at least one lamination assembly. It is preferred within the meaning of the invention that the distortion cushion and/or the curved surfaces of the insert frame replicate or replicates a surface line of a desired surface of the object. By virtue of the fact that the distortion cushion and/or the curved surfaces of the insert frame replicate or replicates the surface line of the desired surface of the object, a curved surface having a desired configuration can be generated during the production of the object. This advantage of the invention can be utilized for example during the production of grinding plates as object in that the grinding plate, after its production, and in spite of the distortion which occurs, has a planar, microstructured surface. This can preferably be achieved in that the tool insert has a curved surface for producing a microstructured grinding plate having a high degree of planarity. It is preferred within the meaning of the invention that the curvature, in collaboration with the microstructuring by the substructures, constitutes the complexity of the object to be molded. It was completely surprising that tool inserts can be provided for the production of such complex structures, such as, for example, grinding plates. It is preferred within the meaning of the invention that the curvature represents a nonplanar surface of the object, with depressions or openings also being able to represent such nonplanar surfaces within the meaning of the invention. It is preferred within the meaning of the invention that the tool insert has, for example, a curvature which is preferably designed to allow the production of a nonplanar object with microstructuring. Of course, the tool insert can also have other, preferably nonplanar, regions in order, for example, to introduce depressions or openings into the object.

A key advantage of the invention is that a nonplanar tool insert can be used to produce a product which, as a result of the planned distortions taken into consideration in the production process, assumes a desired shape which, for example, can be planar. A further advantage of the invention is that the preferably planar tool surface with microstructuring can be iterated by machining the distortion cushion without the laminations of the preferably laminar tool insert having to be changed. This advantage is achieved in particular in that countering is carried out in which the inverse of the distortion of the desired object is used. The term “inverse of the distortion of the desired object” comprises, for example, a countermold which can notionally be obtained, for example, by a three-dimensional impression. The inverse of a curvature is, for example, a depression, or vice versa. In other words, the inverse of a concavely shaped object can be formed by a convex structure, or vice versa.

It is preferred within the meaning of the invention that the individual laminations of the lamination assembly have different functionalities which are imparted by a different microstructuring of the individual laminations.

For example, the substructures of the microstructure or the Velcro hooks of the Velcro hook layer can be generated with tool inserts which, for example, comprise lamination assemblies stacked in an alternating manner. The grinding plate or the object can be produced in particular with a laminar tool insert, wherein the tool inserts serve as molds for the injection molding method. Here, the laminar tool insert can comprise a plurality of individual laminations which form a lamination stack or a lamination assembly. Individual laminations can be removed from this lamination assembly when introducing the microstructures and, in the construction of the final lamination assembly, can serve as spacers in the normal direction of the microstructured laminations. The remaining laminations can be functionalized in that negative microstructures are introduced into the laminations. These negative or depressed microstructures can form the molds for the Velcro hooks of the Velcro layer that are to be produced or for the substructures of the microstructure. The negative microstructures preferably form depressions into which a preferably nonreinforced plastic can enter. After cooling and forced demolding of the grinding plate or of the object, the material which was present in the depressed microstructures of the laminar tool insert forms the Velcro hooks of the Velcro hook layer or the substructures of the microstructure.

The lamination stack can, for example, be assembled in an alternating manner after introducing the depressed microstructures, with the result that an orientation pattern of radially arranged Velcro hook rows or rows of substructures with an alternating A and B orientation can be formed. As a result, an arrangement of the radial rows is preferably made possible in which the rows can be oriented in an alternating manner in the clockwise direction and in the counterclockwise direction. For example, the lamination stack can contain a sequence of laminations arranged as follows: 1) Lamination with a microstructure which generates Velcro hooks or substructures with an A orientation, 2) spacer lamination as spacer, 3) lamination with a microstructure which generates Velcro hooks or substructures with a B orientation, 4) spacer lamination as spacer, etc.

The individual rows of substructures are preferably each generated by an individual lamination. For example, the A- and B-oriented Velcro hooks can have the function(ality) of connecting the grinding plate particularly firmly to the grinding attachment, whereas the laminations which function as spacers make it possible, for example, to vent the liquid plastic material filled during the injection molding method. In this respect, the differently structured individual laminations contribute to the different functions of the substructures of the microstructure.

The expression “lamination” is to be understood within the meaning of the invention as a rolled product; the expression “lamination assembly” is to be understood within the meaning of the invention as a layered three-dimensional structure consisting of layers of such laminations.

The term “lamination” is to be understood within the meaning of the invention as a preferably metallic constituent part of a laminar tool insert into which, for example, negative microstructures can be introduced or which can serve as a spacer between functionalized “laminations” within the tool insert. The term “lamination assembly” is to be understood within the meaning of the invention as an arrangement of a plurality of such laminations, wherein a laminar tool insert comprises at least one lamination assembly consisting preferably of individual laminations arranged in an alternating manner.

A further advantage which can be realized with the invention is that not only a load-appropriate orientation of the substructures of the microstructure can be made possible, but that also objects having widened or additional functionalities can be produced with the invention. If the object is intended, for example, to have an opening or a depression in order to perform a specific task, the invention can be used, for example, to lead the microstructuring of the object around the opening or depression. This preferably means within the meaning of the invention that the substructures of the microstructure can be arranged on the object in such a way that they are precisely not present in the region of the opening or the depression, but in an arrangement optimized for the specific object. Further functionalities of the object can preferably be provided with this optimized arrangement.

A finding on which the invention is based is that laminar, non-interconnected individual laminations of the lamination assemblies of the tool insert can take up shear stresses as a result of transverse force only to a very small degree. Correspondingly, the individual laminations have only a small area moment of inertia. The term “area moment of inertia” is preferably understood within the meaning of the invention as a resistance to a deformation. This property makes it possible to achieve concave and convex curvature by bracing the lamination assembly between two contour-defining surfaces. Consequently, the microstructures can be freely oriented in the plane by the targeted shaping of an insert frame.

In a further aspect, the invention thus relates to a system for the production of an object, wherein the system comprises a tool insert and a sliding element, wherein the sliding element has a surface which is designed as a mating contour to a curved surface of the insert frame. It is very particularly preferred within the meaning of the invention that the sliding element has a functional surface, wherein the functional surface of the sliding element is designed as a mating contour to a curved surface of the insert frame and is situated opposite to this curved surface of the insert frame during production of the complexly shaped object. It is preferred within the meaning of the invention that a sliding element can be used which preferably has a mating contour to the preferably curved surface of the lamination assembly. The sliding element can also preferably be referred to within the meaning of the invention as a “slide” or as a punch. What is meant by these terms is a preferably movably designed mold element in a tool insert which can be moved with or independently of the opening movement. Such sliding elements can be used in particular in injection molding methods. They are designed in particular to demold undercut parts or structures. It is preferred within the meaning of the invention that the sliding element has a concave/convex mating contour to a convex/concave surface of the insert frame of the tool insert. Here, the surface of the insert frame of the tool insert can be referred to as a contour-defining side for the object to be produced, whereas the sliding element is preferably designed in a corresponding manner thereto. The sliding element is preferably designed in the manner of a punch and/or movably in order to remove the sliding element from the opening of the insert frame of the tool insert and to be able to introduce the laminations or lamination assemblies. This preferably means within the meaning of the invention that the sliding element is designed to be movable and to be removable from the opening of the insert frame of the tool insert in order to allow insertion of the laminations or lamination assemblies to generate the microstructuring of the object to be produced. The system for producing an object is illustrated in FIG. 1.

The possibility of orienting the microstructures by pressing the lamination stack between contour-defining surfaces of the insert frame is achieved in the context of the present invention in that curved surfaces can be introduced into the object by virtue of the insert frame having curved surfaces.

In addition to the possibility of freely orienting the microstructures in the plane, a possibility in the context of the present invention is to influence the surface of the microstructure in the Z direction without the e lamination assemblies with the microstructure having to be mechanically reworked. This is achieved in that at least one so-called “distortion cushion” is arranged between the insert frame and the at least one lamination assembly in order to introduce curved surfaces into the object to be produced. In other words, the distortion cushion is designed to counter any distortions.

For example, a “distortion cushion” which represents the surface line of the desired surface can be placed under the lamination assembly. Since the individual laminations butt against this “distortion cushion”, they represent the surface line or the desired surface shape in a stepped manner. For rework or iteration of the distortion, all that is required is adaptation of the distortion cushion without having to rework the lamination assembly. In particular, the provision of a distortion cushion allows countering of distortion in the Z direction. The X, Y and Z directions are explained in the figures and in the description of the figures.

An advantage of using a distortion cushion is in particular that the once-produced lamination assemblies do not have to be changed if iteratively minimal corrections or changes on the object to be produced or the substructures to be produced are required. Rather, the provision of a distortion cushion allows a situation in which only the distortion cushion itself has to be machined and changed in order to perform minimum corrections or changes on the object to be generated by the injection molding method, here the grinding plate.

It is preferred within the meaning of the invention that the lamination assembly is arranged in an insert frame, wherein the lamination assembly in the insert frame forms the laminar tool insert. When using a distortion cushion, it is preferred within the meaning of the invention that the distortion cushion is arranged between the insert frame and the lamination assembly. The distortion cushion preferably represents the surface line of the desired surface. Since the laminations of the lamination assembly butt against the distortion cushion, the laminations or the lamination assemblies represent this surface, preferably in a stepped manner. For rework or iteration of the distortion, all that is required is adaptation of the distortion cushion without having to rework the lamination assembly or the tool insert.

An alternative possibility for producing components is that the insert frame has concavely or convexly curved surfaces which can act as a distortion cushion. The curvatures of the surface of the insert frame are transmitted to the lamination assembly which—as described—is inserted into the insert frame. It is preferred in the context of this embodiment of the invention that the lamination assemblies are braced, for example, between two contour-defining surfaces such that the desired microstructures, such as the Velcro hooks of the Velcro hook layer, can be produced by targeted shaping of the insert frame. Moreover, the microstructures can be freely oriented in the plane by the proposed method.

The invention makes it possible for the inventors to achieve an economical and cost-effective production of injection molding tools for complexly shaped components having a nonplanar, nonlinearly oriented surface which, moreover, can be functionalized with a microstructure. The invention can advantageously be used for orienting the microstructuring in the tool plane (x-y plane) or, for example, for countering distortion with a Z orientation.

In a second aspect, the invention relates to a method for producing a molded object having curved surfaces using a proposed tool insert. The method for producing the object is characterized by the following method steps:
a) providing a lamination assembly which comprises a plurality of individual laminations,
b) providing an insert frame for receiving the lamination assembly, wherein the insert frame and the lamination assembly form the tool insert,
c) introducing curved surfaces into the object in that the insert frame has curved surfaces and/or in that at least one distortion cushion is arranged between the insert frame and the at least one lamination assembly.

It is preferred within the meaning of the invention that the lamination assembly is inserted into an insert frame of the tool insert.

In a further aspect, the invention relates to an object which can be produced with the production method, wherein the object has a basic body and a microstructure on the surface of the basic body, wherein the basic body comprises a fiber-reinforced plastic and a microstructure comprises a nonreinforced plastic. The terms, definitions and technical advantages introduced for the tool insert preferably apply in an analogous manner to the production method and to the object. In an exemplary embodiment of the invention, the object can be a grinding plate onto whose surface can be molded a Velcro hook layer having Velcro hooks. Here, the grinding body can comprise a fiber-reinforced material and the Velcro hook layer can comprise a nonreinforced material.

In other words, the invention relates, in an exemplary embodiment, to a grinding plate which comprises a basic body as supporting structure and also comprises an injection-molded layer, which is preferably completely covered with Velcro hooks, on the surface of the grinding plate. The basic body is preferably produced from a rigid material, whereas the touch-and-close hook layer represents a soft component and consists of a softer, nonreinforced plastic material. The grinding plate serves for receiving a grinding attachment having a fleece underside and a functional side, wherein the functional side is preferably provided with an abrasive.

Tests have shown that grinding plates in which the basic body comprises a fiber-reinforced plastic and the Velcro hook layer comprises a nonreinforced plastic have a high bending stiffness and are therefore very well suited for grinding, in particular for grinding hard substrates, such as concrete. Moreover, the grinding plates can be produced in a particularly simple and cost-effective manner by the two-component injection molding method, wherein in particular the labor effort and the number of manual process steps can be considerably reduced.

It is preferred within the meaning of the invention that materials such as fiber-reinforced polyamide 6 (PA6) or polyamide 66 (PA66) having a mass fraction of glass fibers which is greater than 30% are used as fiber-reinforced plastic for the basic body of the grinding plate. It is particularly preferred within the meaning of the invention to use the fiber-reinforced plastic PA6GF30 for the structural basic body. The soft component from which the Velcro hook layer having the Velcro hooks is preferably formed can be produced, for example, from PA6. It has been shown that this material combination is particularly well suited to producing the components of the grinding plate, preferably in one process. In particular, the material combination of PA6GF30 for the basic body and PA6 for the Velcro hook layer allows a strong, robust connection between the components of the grinding plate, and also flexibility during production. It is possible, for example, to connect the components of the grinding plate to one another in a form-fitting or integrally bonded manner.

With the grinding plate there can be provided in particular grinding plates having a low elongation at break and a high viscosity in the region of the basic body, whereas the grinding plates have a sufficiently high elongation at failure in the region of the Velcro hook layer in order to allow the forced demolding of the Velcro hooks.

The invention can advantageously ensure that a surface of the grinding plate is substantially completely covered by the Velcro hook layer. Consequently, substantially the whole surface of the grinding plate is available for the production of the Velcro fastener connection with the grinding attachment, thereby making it possible to achieve a better adhesive action between the grinding plate and the grinding attachment. This considerably reduces the risk of undesired detachment of the grinding attachment from the grinding plate.

It is preferred within the meaning of the invention that substructures of the microstructure are arranged in rows on the surface of the object, wherein the substructures are oriented in the rows corresponding to the arrangement of the individual laminations in the lamination assembly. The rows of the substructures are preferably present at uniform spacings between the boundaries of the object. It is preferred within the meaning of the invention that the rows are arranged substantially equidistantly to one another. This means in other words that the spacings between the rows are substantially identical. The rows preferably have a spacing in a range from 0.3 to 2 mm, preferably a spacing in a range from 0.5 to 1.5 mm, particularly preferably a spacing from 0.7 to 1.0 mm, and most preferably a spacing of 0.8 mm.

It is preferred within the meaning of the invention that the substructures preferably arranged in rows have different orientations. For example, a first row of substructures can have an orientation A, whereas a second row of substructures can have an orientation B. If the substructures are designed as Velcro hooks, it is possible, for example, for a first row of Velcro hooks to have an opening in a first spatial direction, whereas the second row of Velcro hooks has an opening in an oppositely directed spatial direction.

In an exemplary embodiment of the invention, it is preferred that the Velcro hooks of the rows are oriented in an alternating manner in the clockwise direction and in the counterclockwise direction. This preferably means within the meaning of the invention that the Velcro hooks are present in rows from the outside to the inside, with, for example, the Velcro hooks being oriented in the clockwise direction (orientation A) in the outermost layer, whereas the Velcro hooks in the second outermost layer are oriented in the counterclockwise direction (orientation B). This advantageously results in an orientation pattern of radially arranged Velcro hook rows oriented with an alternating A and B orientation.

It is preferred within the meaning of the invention that a surface of the complexly shaped object is substantially completely covered by the substructures of the microstructure. The invention can advantageously ensure that a surface of a grinding plate as a complexly shaped object is substantially completely covered by or with the Velcro hook layer. Consequently, substantially the whole surface of the grinding plate is available for the production of the Velcro fastener connection with the grinding attachment, thereby making it possible to achieve a better adhesive action between the grinding plate and the grinding attachment. This considerably reduces the risk of undesired detachment of the grinding attachment from the grinding plate.

Further advantages will become apparent from the following description of the figures. The figures, the description and the claims contain numerous features in combination. A person skilled in the art will expediently also consider the features individually and combine them to form useful further combinations.

### BRIEF DESCRIPTION OF THE DRAWINGS

Identical and similar components are denoted by the same reference signs in the figures, in which:

FIG. 1 shows a view of a preferred embodiment of a tool insert

FIG. 2 shows a further view of another preferred embodiment of a tool insert

FIG. 3 shows the use of a preferred embodiment of the tool insert with distortion cushion

FIG. 4 shows a view of a preferred embodiment of a grinding plate as an example of a complexly shaped object

FIG. 5 shows a view of a preferred embodiment of a tool insert

FIG. 6 shows a view of a preferred embodiment of a Velcro hook with its dimensions.

### DETAILED DESCRIPTION

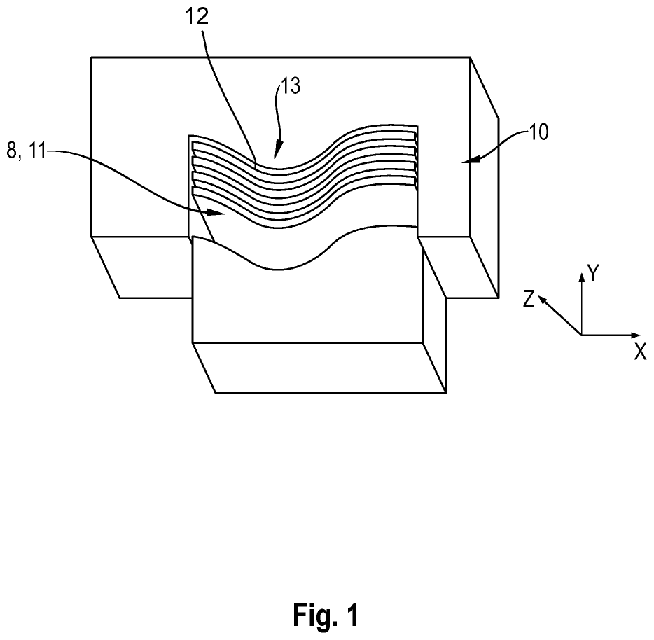

FIG. 1 shows a preferred embodiment of a tool insert 7. In particular, FIG. 1 shows an insert frame 10 which has a curved surface 13. The individual laminations 11 of the at least one lamination assembly 8 can butt against this curved surface 13 of the insert frame 10 and thus replicate the curved surface 13 of the insert frame 10. As a result, the lamination assembly 8 also has a curved surface and can transmit it to the object 1 to be produced to form a curved surface 12. It is preferred within the meaning of the invention that the curved surface 13 of the insert frame 10 can be designed to be concave or convex. The term “concave” preferably stands here for a depression which, for example, can be formed as a mountain valley. The term “convex” preferably stands here for an elevation which, for example, can be formed as a peak of a mountain.

Moreover, FIG. 1 depicts a sliding element 15 which, together with the tool insert 7, can form a system for producing a complexly shaped object 1. The sliding element 15 has a surface which is designed as a mating contour to a curved surface 13 of the insert frame 10. Moreover, the sliding element 15 can be designed so as to be movable in an opening of the insert frame 10.

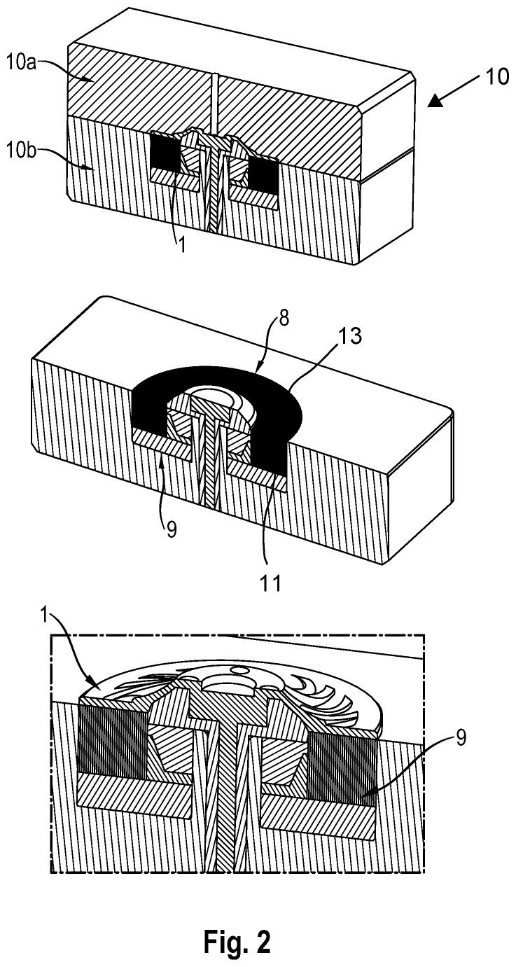

FIG. 2 shows a further preferred embodiment of a tool insert 7. There is illustrated an insert frame 10 which in the left, upper image of FIG. 2 is formed from an upper side 10a and a lower side 10b. It is preferred within the meaning of the invention that the object 1 is formed between the halves of the insert frame 10, in particular by an injection molding method. In the exemplary embodiment of the invention that is illustrated in FIG. 2, the lamination assembly 8, which is formed from a plurality of individual laminations 11, is situated in the insert frame 10. It is preferred within the meaning of the invention that the lamination assembly 8 has a curved surface, wherein this curved surface (here circular) can come about as a result of a curved surface 13 in the insert frame 10 and/or by the provision of a distortion cushion 9 in the insert frame 10. Such a distortion cushion 9 can be seen in particular in FIGS. 2, 3 and 5. The distortion cushion is preferably provided between the lamination assembly 8 and the insert frame 10. The lamination assembly 8, which is illustrated in FIG. 2, is also preferably referred to within the meaning of the invention as a “bent lamination assembly” 8 since it has at least one curved surface.

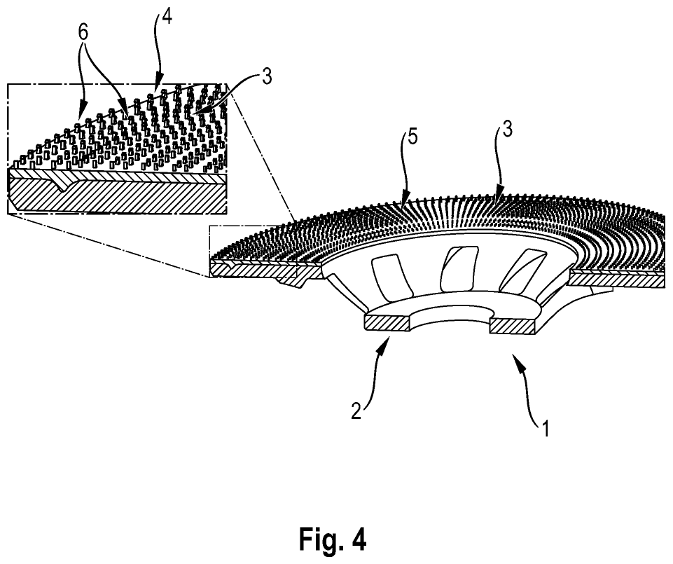

In particular a grinding plate 1 having molded-on Velcro hooks 4 can be produced with the tool insert 7 illustrated in FIG. 2. For the grinding plate 1, it is advantageous if the Velcro hooks 4 (see FIG. 4) are oriented in the circumferential direction. Moreover, it is preferred that the surface 5 (see FIG. 4) of the grinding plate 1 is very planar. The distortion of the grinding plate 1 is, in good approximation, formed rotationally symmetrically. This rotationally symmetrical distortion can be countered by a lamination insert 8 consisting of individual laminations 11 bent substantially in a circular shape and a distortion cushion 9. The distortion cushion 9 can be designed to be conical, straight or rotationally symmetrical. A key advantage of the invention, if it uses the distortion cushion, is that the distortion cushion can assume different conceivable surface shapes. As a result, the method and the tool insert 7 can be used for producing quite different objects and articles. It is very particularly preferred within the meaning of the invention that the surface or its shape can be defined or determined by any desired function of the radius. A corresponding function is preferably identical or substantially identical for all angles of rotation about the center axis.

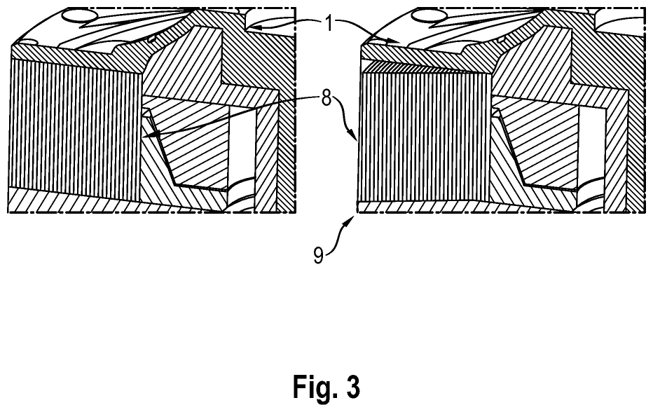

A distortion cushion 9 of straight design is illustrated in FIG. 3 in the left image half, whereas a distortion cushion 9 of conical design is illustrated in the right image half. For the iteration of the tool insert 7, all that is required is for the preferably rotationally symmetrically designed distortion cushion 9 to be machined. Advantageously, the surface 5 of the grinding plate 1 correspondingly results through the possibility of the relative movement of the individual laminations 11. The tool insert 7 is fixed, preferably frictionally, by a central clamping mechanism.

FIG. 3 shows the use of a preferred embodiment of the tool insert 7 with distortion cushion 9. Here, the distortion cushion 9 is used in particular for countering a rotationally symmetrical distortion of the grinding plate 1. FIG. 3 illustrates in particular the grinding plate 1, the bent lamination assembly 8 with its individual laminations 11 and also the distortion cushion 9 of straight or conical design.

FIG. 4 shows a preferred embodiment of a grinding plate 1, wherein the grinding plate 1 illustrates an example of a preferably complexly shaped object 1, wherein the preferably complexly shaped object 1 can in particular be a grinding plate 1. The grinding plate 1 comprises a basic body 2 and a Velcro hook layer 3 which comprises individual Velcro hooks 4. The Velcro hook layer 3 corresponds to the microstructure 3 of the object 1, whereas the Velcro hooks 4 correspond to the substructures 4. The Velcro hooks 4 are preferably arranged in rows 6 which are arranged between the boundaries of a surface 5 of the grinding plate 1. The rows are preferably so-called radial rows 6 which are arranged at uniform, preferably equidistant spacings from outside to inside on the surface 5 of the grinding plate 1. The Velcro hooks 4 are preferably arranged in radial rows 6, with the Velcro hooks 4 of the radial rows 6 being oriented in an alternating manner in the clockwise direction and in the counterclockwise direction. This allows a particularly strong and robust connection between the grinding plate 1 and a grinding attachment to which the grinding plate 1 can be connected by means of a Velcro fastener connection. In FIG. 4 the Velcro hooks 4 have openings which are oriented in a row 6 with an A orientation for example in the clockwise direction, whereas the openings of the Velcro hooks 4 are oriented in a row 6 with B orientation for example in the counterclockwise direction.

It is preferred within the meaning of the invention that the surface 5 of the grinding plate 1 functions as an active surface and is of annular design. The basic body 2 of the grinding plate 1 is formed from or comprises a fiber-reinforced plastic, whereas the Velcro hook layer 3 consists of or comprises a nonreinforced plastic.

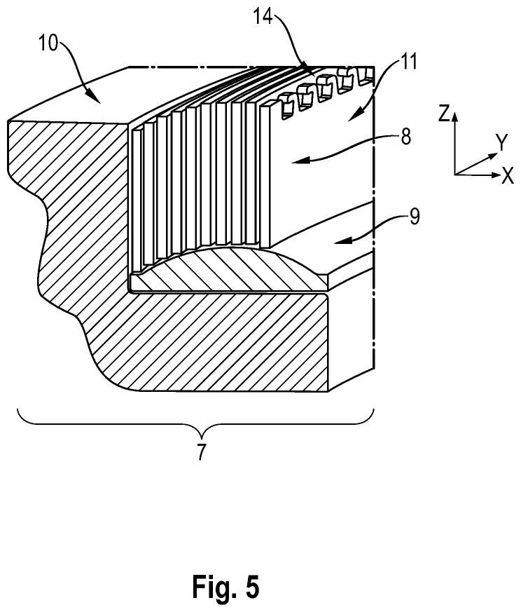

FIG. 5 shows a preferred embodiment of a tool insert 7. The tool insert 7 comprises an insert frame 10 and at least one lamination assembly 8. The lamination assembly 8 is formed from individual laminations 11 which, for example, can be inserted into the insert frame 10 in an alternating manner. Between the insert frame 10 and the lamination assembly 8 there can be arranged a distortion cushion 9 for countering any deformations and/or distortions. The individual laminations 11 of the lamination assembly 8 have depressions which are referred to as negative microstructuring 14 within the meaning of the invention. The negative microstructuring 14 is intended to receive the liquid plastic material and to give it its shape during the production process. It is preferred within the meaning of the invention that the negative microstructuring 14 constitutes a negative representation of the Velcro hook layer 3 or the microstructure 3 and molds the latter during the injection molding method.

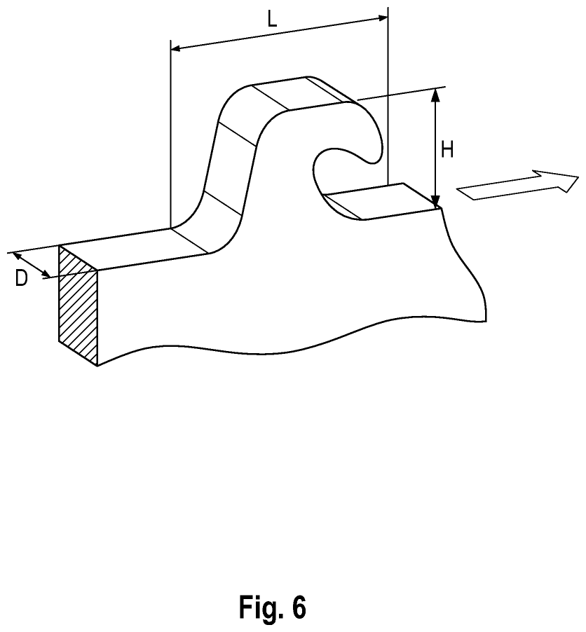

FIG. 6 shows a preferred embodiment of a Velcro hook 4 with its dimensions. In particular, FIG. 6 shows the length L, the thickness D and the height H of an exemplary Velcro hook 4. The opening direction or longitudinal direction of the Velcro hooks 4 is illustrated in FIG. 6 by the two-dimensional arrow which points to the right in the figure. The thickness D of the Velcro hooks 4 can also be referred to as width within the meaning of the invention. This thickness D preferably substantially corresponds to the width of a lamination 11 of the lamination assembly 8 minus any shrinkage of the plastic.

### LIST OF REFERENCE SIGNS

1 Grinding plate or object
2 Basic body
3 Velcro hook layer
4 Velcro hook
5 Surface of the grinding plate
6 Radial rows
7 Tool insert
8 Lamination assemblies
9 Distortion cushion
10 Insert frame
10a: Upper side
10b: Lower side
11 Individual laminations
12 Curved surface of the object
13 Curved surfaces in the insert frame
14 Negative microstructuring of the individual laminations or of the tool insert
15 Sliding element
L Length of a Velcro hook
D Thickness or width of a Velcro hook
H Height of a Velcro hook

1-12. (canceled)

13. A tool insert for the production of an object by an injection molding method, the tool insert comprising:
an insert frame; and
at least one lamination assembly having a plurality of individual laminations, the at least one lamination assembly inserted in the insert frame,
at least one curved surface introducable into the object in that the insert frame has a curved surface or at least one distortion cushion arranged between the insert frame and the at least one lamination assembly.

14. The tool insert as recited in claim 13 wherein the individual laminations of the lamination assembly have different functionalities imparted by a different microstructuring of the individual laminations.

15. The tool insert as recited in claim 13 wherein differently structured individual laminations are arranged in alternating fashion within the at least one lamination assembly of the tool insert.

16. The tool insert as recited in claim 13 wherein the distortion cushion or the curved surface of the insert frame replicates a surface line of a desired surface of the object.

17. The tool insert as recited in claim 13 wherein the distortion cushion is present and designed to counter any distortions.

18. A method for producing an object having curved surfaces using a tool insert as recited in claim 13, the method comprising:
a) providing at least one lamination assembly including a plurality of individual laminations;
b) providing an insert frame for receiving the lamination assembly, wherein the insert frame and the lamination assembly form the tool insert;
c) introducing a curved surface into the object in that the insert frame has a curved surface or in that at least one distortion cushion is arranged between the insert frame and the at least one lamination assembly.

19. An object produceable with the method as recited in claim 18, the object comprising a basic body and a microstructure on the surface of the basic body, wherein the basic body includes a fiber-reinforced plastic and the microstructure includes a nonreinforced plastic.

20. The object as recited in claim 19 wherein substructures of the microstructure are arranged in rows on the surface of the object, and wherein the substructures are oriented in the rows corresponding to the arrangement of the individual laminations in the lamination assembly.

21. The object as recited in claim 20 wherein a surface of the object is completely covered with the substructures of the microstructure.

22. A system for producing an object, wherein the system comprises:
a tool insert as recited in claim 13 and a sliding element, the sliding element having a surface designed as a mating contour to a curved surface of the insert frame.

23. The system as recited in claim 22 wherein the sliding element is designed so as to be movable in an opening of the insert frame.

24. The system as recited in claim 22 wherein the sliding element has a functional surface, wherein the functional surface of the sliding element is designed as a mating contour to a curved surface of the insert frame and is situated opposite to this curved surface of the insert frame during production of the complexly shaped object.
